(19) United States
(12) Patent Application Publication
(10) Pub. No.: US 2006/0077063 A1
(43) Pub. Date: Apr. 13, 2006

(54) Portable monitoring system for recognizing wheeze in lung sounds

(76) Inventors: Yi Ping Cheng, Hsinchu City (TW); Chin Jung Ku, Tongsiao Township (TW)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/245,061

(22) Filed: Oct. 7, 2005

(30) Foreign Application Priority Data
Oct. 13, 2004 (TW) 093130984

(51) Int. Cl. G08B 23/00

(52) U.S. Cl. 340/573.1

(57) ABSTRACT

A portable monitoring system for recognizing wheeze in lung sounds can detect the occurrence of wheeze from the neck of an asthmatic. The portable monitoring system comprises an acoustic sensor, a signal processor and a wireless signal transmission module, a remote analyzer and an alarm generator. The acoustic sensor is placed next to the windpipe of the asthmatic to collect the acoustic signals when he breathes. The signal processor and remote analyzer analyze the acoustic signals to recognize whether the wheeze, in the form of specified signals, exists. If the wheeze is found, the wireless signal transmission module or the remote analyzer directly instructs the alarm generator to generate an alarm so as to notify someone to give medical treatment to the asthmatic.

### BACKGROUND OF THE INVENTION

1. Field of the Invention

The present invention relates to a portable monitoring system for recognizing wheeze in lung sounds and, more particularly, a monitoring system capable of detecting whether any wheeze exists in lung sounds.

2. Description of the Related Art

Asthma is a common chronic illness for children; there are around five million American children suffering from such an illness. Similarly, ten percent of Taiwanese children have asthma. That is, at least one out of ten children suffer asthma torment. Asthma was continuously included in the top ten causes of death at Taiwan before 2002, and then became the eleventh-greatest death cause in 2002. There were almost 1600 asthmatics who died from asthma attacks every year in Taiwan.

Lung sounds are caused from the vibration in respiratory passages when air passes through the respiratory passages during breathing. For general clinical diagnosis, doctors utilize stethoscopes to diagnose the conditions of patients. Up to now, there have been several methods of automatic lung sound diagnosis and analysis put forth sequentially, such as the disclosures in U.S. Pat. Nos. 6,139,505 and 6,261,238. Regarding these techniques, a plurality of microphones, collecting acoustic signals, are attached to the chest of a patient. Afterwards, the collected acoustic signals are analyzed to recognize what illnesses the patient suffers from, such as pneumonia, emphysema, bronchitis and asthma. In this regard, such a diagnosis system is appropriate to be used in general clinical diagnosis because the patient who is bedridden or sleeping feels uncomfortable with the attached microphones over a long term. On the other hand, specific acoustic signals characterizing each kind of lung illness must be collected in advance so that unrecognized acoustic signals can have a spectrum analysis and be compared with the database consisting of the collected specific acoustic signals. Therefore, the diagnosis system is very complicated.

PCT (patent convention treatment) patent publication No. 01/19243 discloses an asthma inspection apparatus. Even though the apparatus is simplified as a microphone-shaped device, sampled signals and corresponding statistical data are still necessarily obtained and stored in the memory components of the apparatus for comparison with unrecognized acoustic signals in advance. Apparently, whether the apparatus can exactly recognize an asthma attack is completely dependent on what acoustic signals are sampled.

In conclusion, the medical equipment industry currently desires to develop an asthma detector that is portable and convenient for a bedridden patient to use. Such an asthma detector is suitable for an asthmatic to wear for a long term. The beginning of an asthma attack, especially, should be actually sensed by the detector.

### SUMMARY OF THE INVENTION

An objective of the present invention is to provide a portable monitoring system for recognizing wheeze in lung sounds. The system can chronically, continuously and non-invasively detect whether an asthma attack occurs.

Another objective of the present invention is to provide a portable monitoring system for recognizing wheeze in lung sounds. The system can detect whether special acoustic signals representing wheeze exists in lung sounds. If so, an alarm is generated by the system to notify someone such as a nurse or a doctor to give medical treatment to the asthmatic.

To achieve the objective, the present invention discloses a portable monitoring system for recognizing wheeze in lung sounds that can detect the occurrence of wheeze from the neck of an asthmatic. The portable monitoring system comprises an acoustic sensor, a signal processor and a wireless signal transmission module, a remote analyzer and an alarm generator. The acoustic sensor is placed next to the windpipe of the asthmatic to collect the acoustic signals when he breathes. The signal processor and remote analyzer analyze the acoustic signals to recognize whether the wheeze, or specified signals, exists. If the wheeze is found, the wireless signal transmission module or the remote analyzer directly instructs the alarm generator to generate an alarm so as to notify someone to give medical treatment to the asthmatic.

On the other hand, the acoustic signals are processed by the signal processor. If wheeze frequencies are found in the processed signals, the wireless signal transmission module promptly transmits wireless alarm signals to the alarm generator. Receiving the wireless alarm signals, the alarm generator generates an alarm such as warning sounds, warning words or a warning light. Of course, a signal cable can replace the wireless signal transmission module to transmit signals on solid metal wires so as to prevent other medical appliances in the same hospital from being affected by the interference caused by the wireless signals.

Furthermore, the signal processor can detect whether the wheeze, represented by specified signals, exists in the acoustic signals. If so, the alarm generator is instructed by the signal processor to send an alarm.

### BRIEF DESCRIPTION OF THE DRAWINGS

The invention will be described according to the appended drawings in which:

FIG. 1 is a schematic diagram of a portable monitoring system for recognizing wheeze in lung sounds used by an asthmatic in accordance with the present invention;

FIG. 2(a) is a function block diagram of the portable monitoring system in accordance with the present invention;

FIG. 2(b) is another function block diagram of the portable monitoring system in accordance with the present invention;

FIG. 3 is a function block diagram of the portable monitoring system in accordance with another embodiment of the present invention; and

FIG. 4 is a flow chart of wheeze reorganization executed by the portable monitoring system.

### PREFERRED EMBODIMENT OF THE PRESENT INVENTION

When asthma attacks an asthmatic, not only shrunken windpipes affect the airflow that the asthmatic inhales and exhales, but also, wheeze occurs. According to statistical data, ninety percent of asthmatics wheeze after an asthma attack. Therefore, we can make sure whether an asthma attack starts in light of this wheeze symptom. The American Thoracic Society clearly defines wheeze as an acoustic signal whose dominant frequency is at 400 Hz lasting over 250 ms. (referring to Peter J. Barnes, Michael M. Grunstein, Alan R. Leff, Ann J. Woolcock, “Asthma.”, Philadelphia: Lippincott-Raven, 1995) Because wheeze is part of the high-frequency band of lung sounds, neck skin adjacent to the windpipe is the most appropriate place for the asthmatic to monitor the occurrence of asthma. In fact, acoustic frequencies are resulted from the vibration of windpipes induced by the passing airflow, and vary in human races or sex. The present portable monitoring system specially sets the frequency margin of wheeze detection above 350 Hz. Therefore, no matter what human race or sex the asthmatic is, the system is also assured.

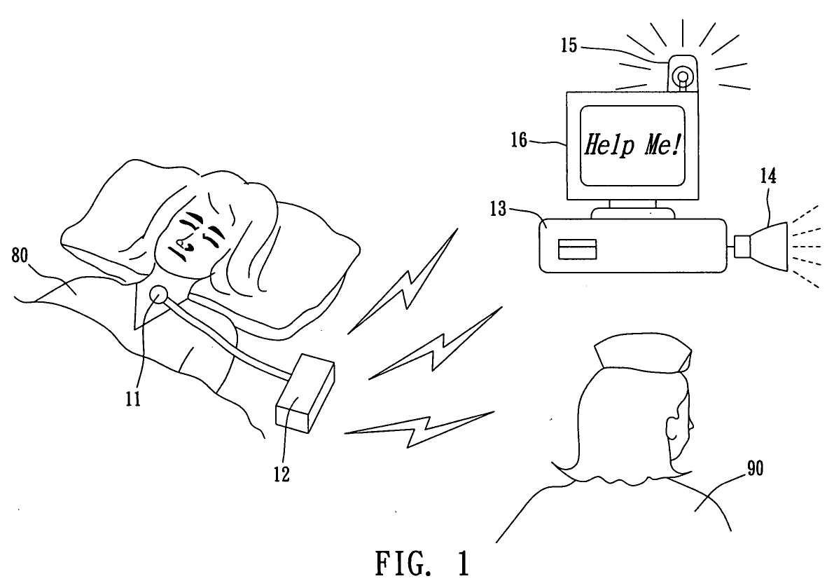

FIG. 1 is a schematic diagram of a portable monitoring system for recognizing wheeze in lung sounds used by an asthmatic in accordance with the present invention. The portable monitoring system includes an acoustic sensor 11 attached to the neck of an asthmatic 80 for collecting acoustic signals caused by the vibration of her lungs during breathing. The acoustic signals are converted to radio frequency (RF) signals by a wireless signal transmission module 12. The RF signals are received and processed by a remote analyzer 13. When the remote analyzer 13 detects the existence of the wheeze frequencies, it promptly instructs an amplifier 14, a warning light 15 and a display screen 16 to show corresponding alarms. Remote medical personnel 90 can instantly prepare an appropriate medical treatment for the asthmatic 80 according to these alarms. Therefore, an asthmatic does not grow worse in either a deep-sleep state or an unconscious state.

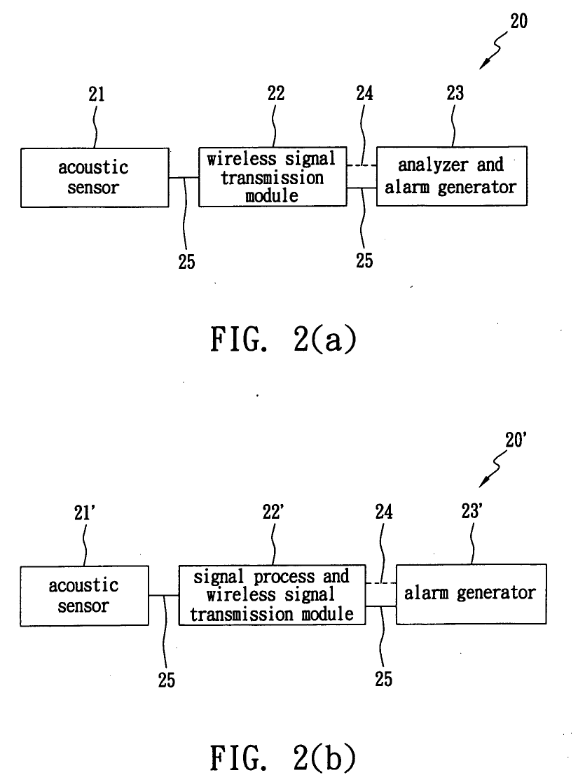

FIG. 2(a) is a function block diagram of the portable monitoring system in accordance with the present invention. An acoustic sensor 21 is connected to a wireless signal transmission module 22 by a cable 25. The wireless signal transmission module 22 can transform the acoustic signals into RF signals or infrared signals, wherein RF signals can penetrate blocks and be transmitted to a far-away site. In addition to wireless communication 24, the wireless signal transmission module 22 uses a solid cable 25 for directly transmitting the acoustic signals to the combination of an analyzer and an alarm generator 23. Because the analyzer and alarm generator are all placed at a remote site, the volume of the wireless signal transmission module 22 is reduced. Therefore, the shrunken wireless signal transmission module 22 is suitable for the asthmatic 80 to wear. He can even walk freely within the range of the RF signals.

With the technical progress of the DSP (digital signal progress) IC, both signal analysis and signal transmission functions can be integrated into an apparatus carried or worn by the asthmatic 80. In this regard, FIG. 2(b) shows a signal process and signal transmission module 22′ included in a portable monitoring system 20′ for recognizing wheeze in lung sounds. Similarly, a cable 25 directly connects an acoustic sensor 21′ and wireless signal transmission module 22′. The module 22′ not only recognizes whether wheeze exists in the acoustic signals collected by the acoustic sensor 21′, but also instantly generates RF signals for instructing an alarm generator 23′ to notify the medical personnel 90 to care for the asthmatic 80.

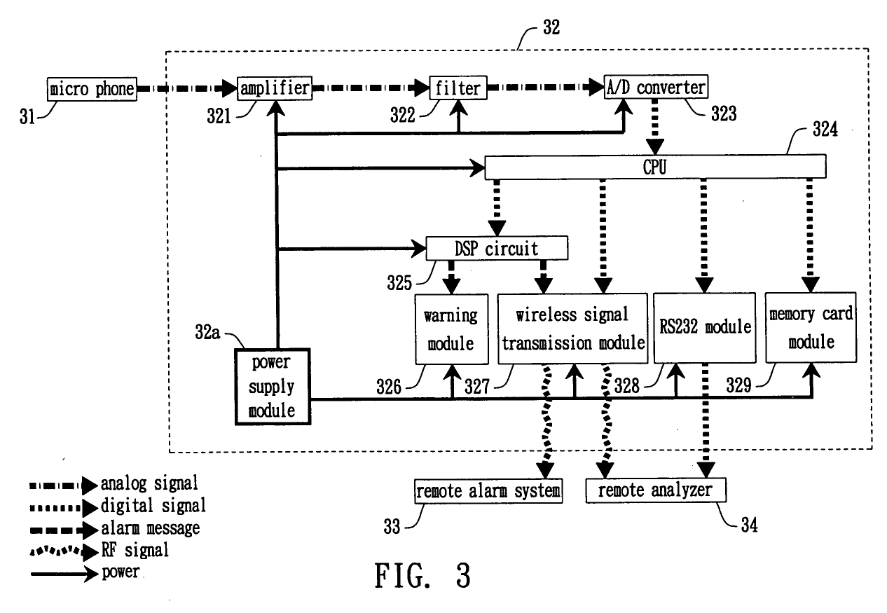

FIG. 3 is a function block diagram of the portable monitoring system in accordance with another embodiment of the present invention. A microphone 31 is used to collect the lung sounds from the neck of the asthmatic 80. The collected acoustic signals are transformed into analog signals, and then the analog signals are amplified by the amplifier 321 of a signal process and signal transmission module 32. A filter 322 filters the low-frequency band of the amplified signals. The residual frequency bands of the amplified signals are converted to digital signals by an A/D (analog-to-digital) converter 323. The digital signals are inputted into a CPU (central processing unit) 324. The output mode of the signal process and signal transmission module 32 is designated by the CPU 324. The CPU 423 also controls a DSP (digital signal processing) circuit 325 to detect the wheeze. If the specific frequencies representing the wheeze are detected, the DSP circuit 325 instantly sends an alarm directly to a warning module 326 or to a wireless signal transmission module 327 so that a remote alarm system 33 is instructed to raise an alarm by RF signals. The warning module 326 can also trigger other alarms by cables.

Furthermore, the CPU 423 can optionally output the digital signals to the wireless signal transmission module 327 or an RS232 module 328, and then the digital signals are converted to RF signals or electrical signals complying with RS232's format that are transmitted separately to a remote analyzer 34. The remote analyzer 34 executes an accurate spectrum analysis and wheeze reorganization, and can continuously collect the lung sounds of asthmatics into databases for pathological searches. There is a removable memory card module 329 placed at the signal process and signal transmission module 32 for continuously recording the lung sounds of the asthmatic. Each component of the signal process and signal transmission module 32 is powered by a power supply module 32a.

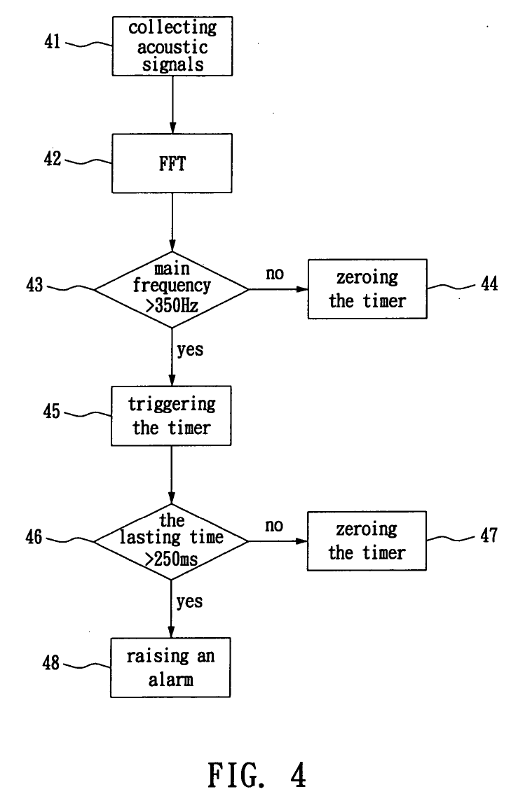

FIG. 4 is a flow chart of wheeze reorganization executed by the portable monitoring system. As Step 41 shows, the acoustic signals of the asthmatic, previously collected, are transformed into signals in the frequency domain by fast Fourier transform (FFT) 42. According to Step 43, the main frequency of the transformed signals is checked to see if it is larger than 350 Hz. If it is not, a timer is set to zero, as Step 44 shows. If it is, the timer starts to count how long the main frequency existing in the lung sounds lasts, as Step 45 shows. Afterward, following Step 46, the lasting time is checked to see if it is larger than 250 ms. If it is not, the timer is set to zero, as Step 47 shows. If it is, an alarm is raised, as Step 48 shows.

The above-described embodiments of the present invention are intended to be illustrative only. Numerous alternative embodiments may be devised by persons skilled in the art without departing from the scope of the following claims.

What is claimed is:

1. A portable monitoring system for recognizing wheeze in lung sounds of an asthmatic, comprising:
an acoustic sensor placed on the asthmatic's neck, for collecting acoustic signals of the lung sounds;
an alarm generator capable of generating an alarm; and
a remote analyzer utilizing a software program to analyze whether the wheeze exists in the acoustic signals and instructing the alarm generator to generate an alarm after affirming the existence of the wheeze.

2. The portable monitoring system of claim 1, wherein the remote analyzer further includes a personal computer, a software program for detecting the occurrence of the wheeze and an auxiliary alarm generator.

3. The portable monitoring system of claim 1, further comprising a wireless signal transmission module that converts output signals from the acoustic sensor to wireless signals, and the remote analyzer detects whether the wheeze exists in the wireless signals after receiving the wireless signals.

4. The portable monitoring system of claim 1, wherein the wheeze exists if the main frequency of the acoustic signals is larger than 350 Hz, and the main frequency lasts over 250 ms.

5. The portable monitoring system of claim 1, further comprising a DSP IC detecting the existence of the wheeze.

6. The portable monitoring system of claim 1, further comprising a removable memory card module for recording the acoustic signals.

7. The portable monitoring system of claim 1, wherein the acoustic sensor is a microphone.

8. The portable monitoring system of claim 1, further comprising a central processing unit (CPU) designating output modes of the signal processor.

9. The portable monitoring system of claim 1, further comprising an analog-to-digital converter transforming the acoustic signals into digital signals.

10. The portable monitoring system of claim 1, further comprising an amplifier amplifying the acoustic signals and a filter filtering low-band frequencies of the acoustic signals.

11. The portable monitoring system of claim 1, further comprising an RS232 module outputting signals complying with RS232 format.

12. The portable monitoring system of claim 1, wherein the acoustic sensor transmits the acoustic signals to the remote analyzer by either a wireless means or a cable.

13. The portable monitoring system of claim 1, further comprising a signal processor detecting the existence of the wheeze in the acoustic signals and instructing the alarm generator to generate an alarm after affirming the existence of the wheeze.

14. The portable monitoring system of claim 13, wherein the signal processor includes a wireless signal transmission module that converts output signals from the signal processor to wireless signals, and the alarm generator generates the alarm after receiving the wireless signals.

15. A portable monitoring system for recognizing wheeze in lung sounds of an asthmatic, comprising:
an acoustic sensor placed on the asthmatic's neck, for collecting acoustic signals of the lung sounds;
an alarm generator capable of generating an alarm; and
a signal processor detecting the existence of the wheeze in the acoustic signals and instructing the alarm generator to generate an alarm after affirming the existence of the wheeze.

16. The portable monitoring system of claim 15, wherein the signal processor includes a wireless signal transmission module that converts output signals from the signal processor to wireless signals, and the alarm generator generates the alarm after receiving the wireless signals.

17. The portable monitoring system of claim 15, wherein the signal processor includes a removable memory card module for recording the acoustic signals.

18. The portable monitoring system of claim 15, wherein the signal processor includes a central processing unit (CPU) designating output modes of the signal processor.

19. The portable monitoring system of claim 15, wherein the signal processor includes an analog-to-digital converter transforming the acoustic signals into digital signals.

20. The portable monitoring system of claim 15, wherein the signal processor includes an amplifier amplifying the acoustic signals and a filter filtering low-band frequencies of the acoustic signals.

21. The portable monitoring system of claim 15, wherein the signal processor includes an RS232 module outputting signals complying with RS232 format.

22. The portable monitoring system of claim 15, wherein the signal processor comprises a digital signal processing (DSP) circuit or a DSP IC firmware program detecting the existence of the wheeze.

23. A portable monitoring method for recognizing wheeze in lung sounds, comprising the steps of:
collecting acoustic signals of an asthmatic;
checking whether a main frequency of the acoustic signals is larger than 350 Hz and whether the main frequency lasts over 250 ms; and
generating an alarm when both aforesaid checks are affirmative.

24. The portable monitoring method of claim 23, wherein the wheeze exists if both the checks are affirmative.
